(19) United States
(12) Patent Application Publication
(10) Pub. No.: US 2014/0379540 A1
(43) Pub. Date: Dec. 25, 2014

(54) TRAVEL INFORMATION COMMUNICATION SYSTEM

(71) Applicant: Bank of America Corporation, Charlotte, NC (US)

(72) Inventors: Kelli R. Malone, Matthews, NC (US); Tammy L. Brunswig, Fort Mill, SC (US); Sarah Overcash, Charlotte, NC (US); Jason M. Tobias, Camden, ME (US); Michael J. Curtis, Lafayette, PA (US)

(21) Appl. No.: 13/924,090

(22) Filed: Jun. 21, 2013

(51) Int. Cl. G06Q 40/00

(52) U.S. Cl. CPC G06Q 40/02
USPC 705/35

(57) ABSTRACT

Embodiments of the invention are directed to apparatus, methods, and computer program products for a travel flag communication system. In some embodiments, an apparatus is configured to: receive a first status associated with a user account; receive information from a user associated with the user account, wherein information comprises at least a start date of travel, an end date of travel, and at least one destination of travel; change status of the user account from the first status to a second status based on at least the start date of travel and the destination of travel; and revert status of the user account to the first status based on at least the end date of travel.

### BACKGROUND

There is a need for a system that enables a user to communicate the user's travel information to a financial institution to enable continuous access to the user's account and to prevent any possible interruption in the user's account service.

### BRIEF SUMMARY

Embodiments of the invention relate to apparatus, methods, and computer program products receiving a first status associated with a user account; receiving information from a user associated with the user account, wherein information comprises at least a start date of travel, an end date of travel, and at least one destination of travel; changing status of the user account from the first status to a second status based on at least the start date of travel and the destination of travel; and reverting status of the user account to the first status based on at least the end date of travel.

In some embodiments, a transaction initiated in the destination of travel between the start date of travel and end date of travel may not trigger a notification.

In some embodiments, the transaction may be initiated using at least one of a debit card, a credit card, and a mobile device.

In some embodiments, triggering a notification may comprise placing a hold on a transaction.

In some embodiments, triggering a notification may comprise limiting access to at least one of the debit card, the credit card, and the mobile device.

In some embodiments, releasing the hold placed on a transaction may comprise a user authentication requirement.

In some embodiments, the notification may not be triggered for transactions at specific merchant locations.

In some embodiments, the notification may not be triggered for transactions in specific currencies.

In some embodiments, the notification may not be triggered for transactions at specific destination of travel.

In some embodiments, the start date of travel, the end date of travel, and the destination of travel may be modifiable.

In some embodiments, the destination of travel may be modifiable during a time period between the start date of travel and the end date of travel.

In some embodiments, the end date of travel may be modifiable during the time period between the start date of travel and end date of travel.

In some embodiments, receiving information may comprise initiating the presentation of a user interface to the user, wherein the user interface may comprise a first interface enabling the user to select a first option.

In some embodiments, receiving information may comprise initiating the presentation of a second interface to the user enabling the user to select a second option, in response to selecting the first option.

In some embodiments, receiving information may comprise initiating the presentation of a third interface to the user enabling the user to enter at least the start date of travel, the end date of travel, and at least one destination of travel.

In some embodiments, the presentation of the user interface may be initiated on a mobile device.

In some embodiments, the presentation of the user interface may be initiated on an online banking platform.

In some embodiments, changing the status of the user account may comprise sending a notification of acknowledgement to the user.

### BRIEF DESCRIPTION OF THE DRAWINGS

Having thus described embodiments of the invention in general terms, reference will now be made to the accompanying drawings, where:

FIG. 1 illustrates a high-level process flow of the travel communication system, in accordance with embodiments of the present invention;

FIG. 2A illustrates an exemplary first interface of the travel communication system on a mobile device, in accordance with embodiments of the present invention;

FIG. 2B illustrates an exemplary second interface of the travel communication system on a mobile device, in accordance with embodiments of the present invention;

FIG. 2C illustrates an exemplary third interface of the travel communication system on a mobile device, in accordance with embodiments of the present invention;

FIG. 3 illustrates an exemplary success notification page of the travel communication system on an online banking platform, in accordance with embodiments of the present invention; and

FIG. 4 illustrates the system environment of the travel communication system, in accordance with embodiments of the present invention.

### DETAILED DESCRIPTION OF THE EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for a travel information communication system. The present invention allows customers to use an online banking platform, a mobile device, and/or the like, to enter travel information for the accounts they will be using while travelling. This information may prevent interruption in account service during travel.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g. a banking account), a savings account, an investment account, a money market account, a time deposit, a demand deposit, a pre-paid account, a credit account, a non-monetary user profile that includes only personal information associated with the user, or the like. The account is associated with and/or maintained by an entity. In other embodiments, an “entity” may not be a financial institution.

In some embodiments, the “user” may be a customer (e.g. an account holder or a person who has an account (e.g. banking account, credit account, or the like) at the entity). In alternate embodiments, the “user” may be a merchant (e.g. a business, a vendor, a service provider, or the like). The user may also be an agent (customer service representative, internal operations specialist, bank teller, account manager, or the like) associated with the entity.

As used herein, the “mobile device” may be a wide variety of computing devices. In some embodiments, the mobile device may refer to a smart phone, a laptop, a tablet, or the like. In other embodiments, the mobile device may refer to a desktop or rack-mounted computing device.

The present invention embraces a travel communication system configured to receive information from a user associated with the user account, wherein information comprises at least a start date of travel, an end date of travel, and at least one destination of travel. In response to receiving the information, the system may change a status of the user account from the first status to a second status based on at least the start date of travel and the destination of travel. In some embodiments, the first status may include tracking the user's financial account for account related activity such as ATM transactions (e.g., withdrawal and deposit), merchant transactions using a debit card, a credit card, a mobile device, and/or the like. In some embodiments, tracking merchant transactions may include tracking merchant transaction location, merchant transaction amount, merchant transaction frequency, and/or the like. In some embodiments, a second status may include recognizing the user's travel plans with the information received to avoid triggering a notification. In response to changing the status of the user account from a first status to a second status based on at least the start date of travel and the destination of travel, the system may revert the status of the user account to the first status based on at least the end date of travel.

In some embodiments, a transaction initiated in the destination of travel between the start date of travel and end date of travel may not trigger a notification. In some embodiments, the transaction is initiated using at least one of a debit card, a credit card, and a mobile device. In some embodiments, triggering a notification may comprise placing a hold on a transaction. In some other embodiments, triggering a notification may comprise limiting access to at least one of the debit card, the credit card, and the mobile device.

In some embodiments, releasing the hold placed on a transaction may comprise a user authentication requirement. In one embodiment, the notification may not be triggered for transactions at specific merchant locations. In another embodiment, the notification may not be triggered for transactions in specific currencies. In some other embodiments, the notification may not be triggered for transactions at specific destinations of travel.

In some embodiments, the start date of travel, the end date of travel, and the destination of travel may be modifiable. In some other embodiments, the destination of travel may be modifiable during a time period between the start date of travel and the end date of travel. In one aspect, the end date of travel may be modifiable during the time period between the start date of travel and end date of travel. In some embodiments, receiving information may comprise initiating the presentation of a user interface to the user, wherein the user interface comprises a first interface may enable the user to select a first option. In some embodiments, the first interface may include one or more options such as accounts, offers, settings, and/or the like. In response to selecting a first option, initiating the presentation of a second interface to the user enabling the user to select a second option. In some embodiments, the second interface may include one or more options such as support, tools, travel, and/or the like. In response to selecting a second option, initiating the presentation of a third interface to the user may enable the user to enter at least the start date of travel, the end date of travel, and at least one destination of travel.

In some embodiments, the presentation of the user interface may be initiated on a mobile device. In some other embodiments, the presentation of the user interface may be initiated on an online banking platform. In one aspect, changing the status of the user account may comprise sending a notification of acknowledgement to the user.

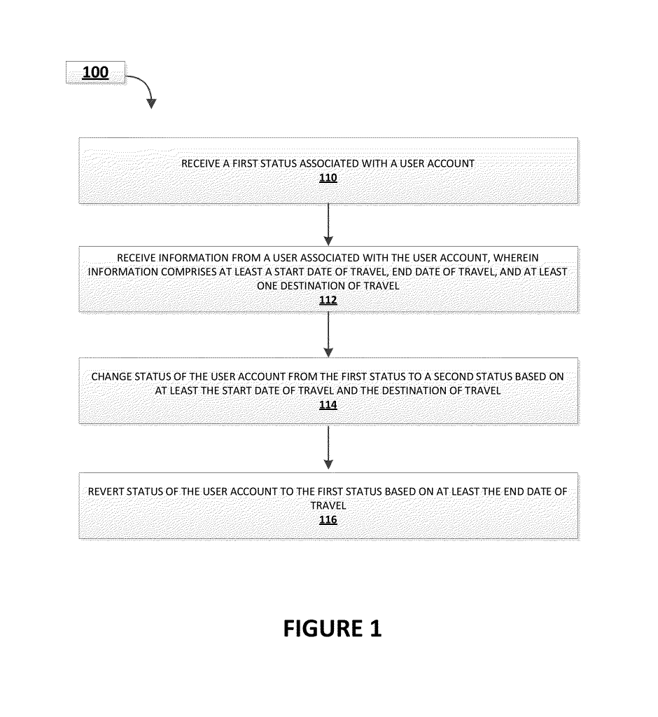

FIG. 1 illustrates a high-level process flow 100 of the travel communication system via a transfer network. At block 110, the system comprises receiving a first status associated with a user account. At block 112, the system then receives information from the user associated with the user account, wherein information comprises at least a start date of travel, end date of travel, and at least one destination of travel. In some embodiments, the information received from the user may include a contact number at which the user may be reached at any time during the time period between the start date of travel and end date of travel. In some other embodiments, the information received from the user may include additional information such as name and address of the hotel at which the user plans to stay during travel, an alternative contact information in case the user cannot be reached, or the like.

At block 114, the system may change the status of the user account from a first status to a second status based on at least the start date of travel and the destination of travel. For example, the user living in the North Carolina may conduct a majority of transactions in and around the state. If the user decides to go on vacation to a different state or a different country without adequate notice, the entity associated with the user account may recognize transactions as unauthorized and interrupt the service provided to the user. However, if the user provides the information such as start date of travel, end date of travel, and/or destination of travel, the claimed system associated with the entity may change the status of the user account to incorporate the destination of travel and avoid triggering a notification during the time period between the start date of travel and the end date of travel. At block 116, the system may revert the status of the user account to the first status based on at least the end date of travel.

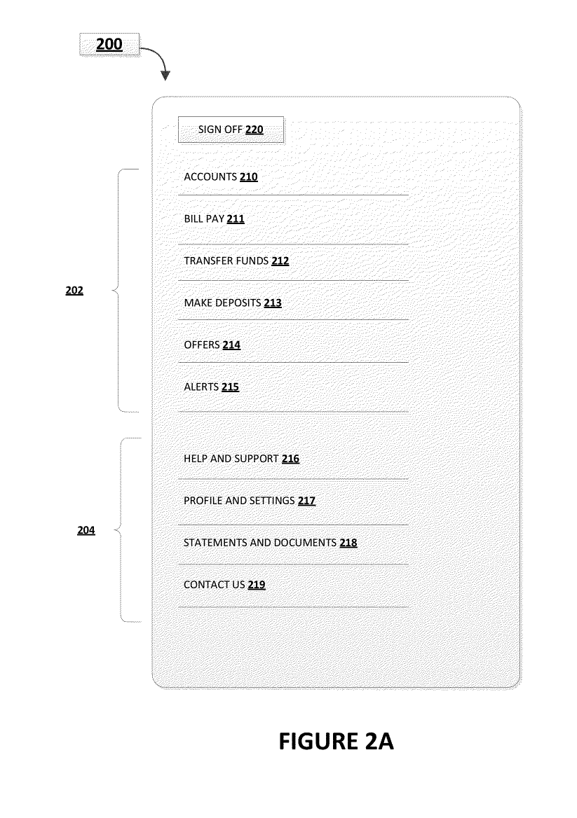

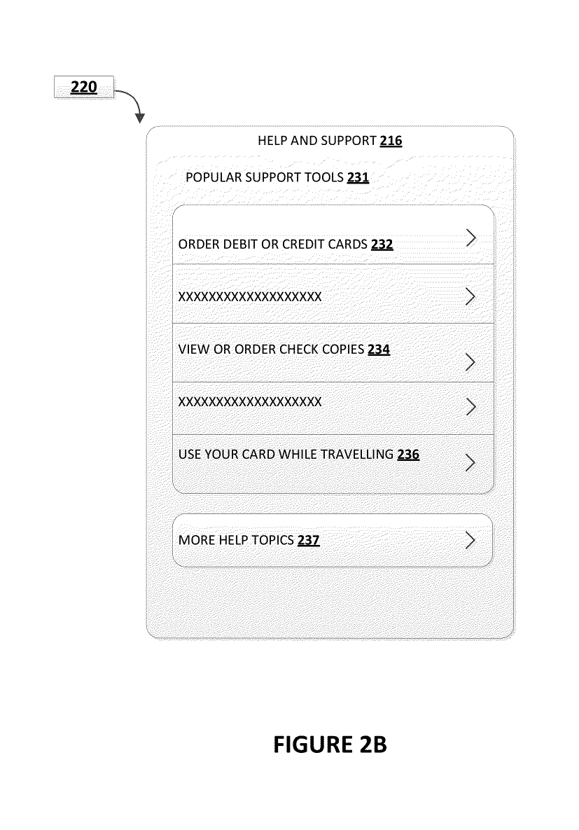

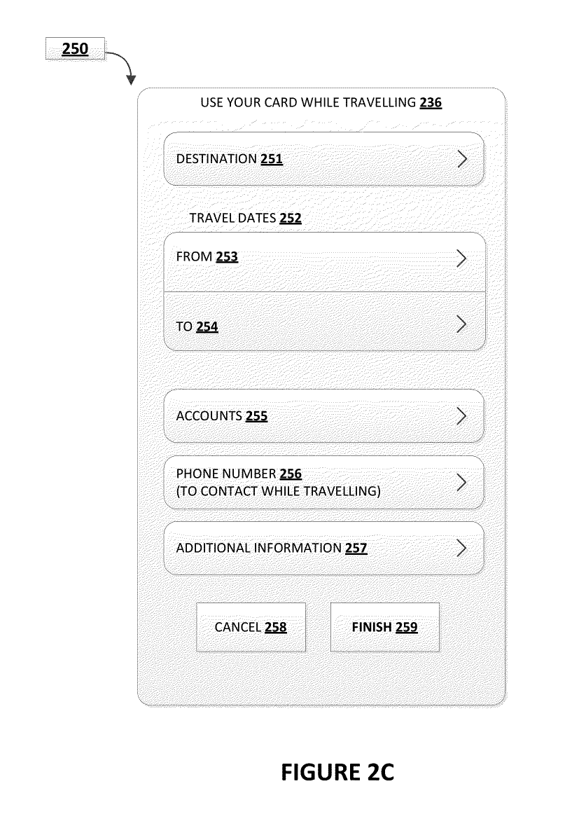

FIG. 2A illustrates an exemplary first interface 200 presented to the user on a mobile device. In some embodiments, the first interface may include options associated with the user account 202 which includes but is not restricted to accounts 210, bill pay 211, transfer funds 212, make deposits 213, offers 214, and/or alerts 215. In some other embodiments, the first interface 200 may include other options 204 which includes but is not restricted to help and support 216, profile and settings 217, statements and documents 218, and/or contact us 219. The user may select one or more options associated with the first interface 200 for further action. In some embodiments, the user may select the help and support 216 option. In response to selecting the help and support option 216, the system may initiate the presentation of a second interface 220 to the user. In some embodiments, the first interface 200 may include a sign off 220 option for the user to safely exit the application.

FIG. 2B illustrates an exemplary second interface 220 presented to the user on a mobile device in response to the selection of the help and support 216 option. In some embodiments, the help and support 216 option may include popular support tools 213 such as order debit or credit cards 232, view or order check copies 234, user your card while travelling 236, and/or more help topics 237. The user may select one or more options associated with the second interface 220 for further action. In some embodiments, the user may select use your card while travelling option 236 option. In response to selecting the use your card while travelling option 236, the system may initiate the presentation of a third interface 250 to the user.

FIG. 2C illustrates an exemplary third interface 250 presented to the user on a mobile device in response to the selection of the use your card while travelling 236 option. In some embodiments, the use your card while travelling 236 option may include one of more options such as destination 251, travel dates 252, which further includes from 253 and to 254 options to enter the dates of travel, accounts 255, phone number (to contact while travelling) 256, and additional information 257.

In some embodiments, the user may select the destination 251 option to enter the destination of travel. In one aspect, the destination 251 option may include an option of entering one or more travel destinations. In some other embodiments, the user may choose the travel dates 252 option to enter from 253 and to 254 dates as start date of travel and end date of travel respectively. In one aspect, the start date of travel, the end date of travel, and the destination of travel are modifiable. In another aspect, the user may modify the destination of travel during the time period between the start date of travel and end date of travel using a mobile device, an online banking platform, or the like. In alternative aspects, the user may modify the end date of travel during the time period of travel between the start date of travel and the end date of travel using a mobile device, an online banking platform, or the like. For example, initially a user may plan a vacation to France from the United States with a start date of travel Jun. 7, 2013 and an end date of travel Jun. 14, 2013. On Jun. 12, 2013, while in France, the user may decide to visit Ireland, Italy, and Germany and extend the end date of travel to Jun. 28, 2013. The user may modify the destination of travel and the end date during the time period between Jun. 7, 2013 and Jun. 14, 2013 by communicating the information to the entity using the travel communication system on a mobile device, an online banking platform, or the like.

In some embodiments, the user may choose the accounts 255 option to identify a user account (e.g., checking account, savings account, or the like), which the user plans on using to conduct transactions at the destination of travel during the time period between the start date of travel and the end date of travel. In some other embodiments, the user may select phone number 256 option to enter contact information associated with the user during the time of travel. In some other embodiments, the user may select additional information 257 to provide specifics of travel such as name of the hotel in which the user may stay at the destination, emergency contact information, and/or the like. In addition, the third interface 250 may include a finish 259 option for the user to confirm and enter the information into the travel communication system, or the cancel 258 option for the user to cancel the information entered.

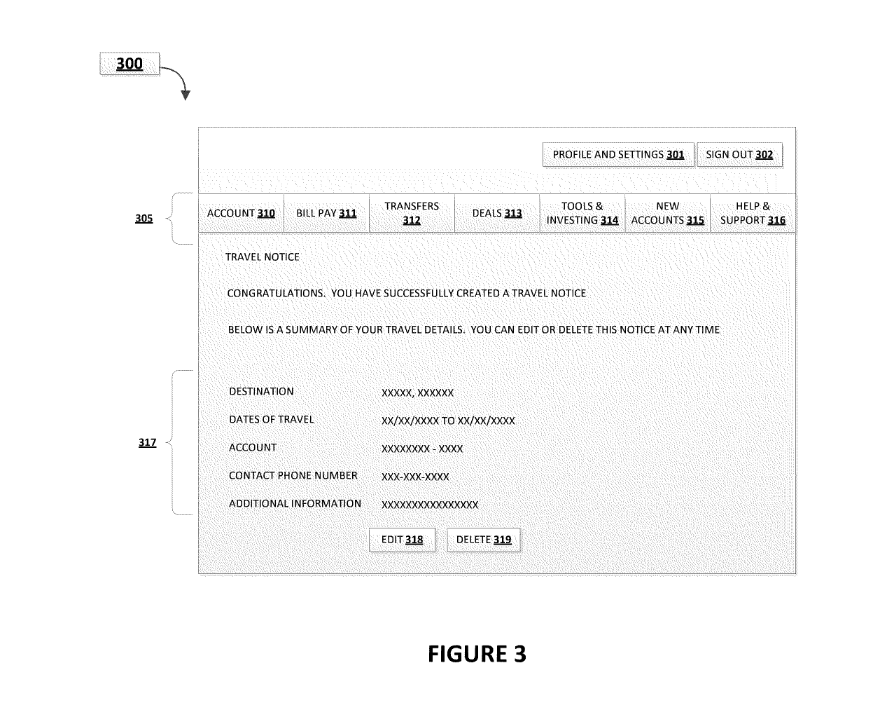

FIG. 3 illustrates an exemplary success notification page 300 associated with the online banking platform. In some embodiments, the success notification page 300 may include account options 305 such as account 310, bill pay 311, transfers 312, deals 313, tools and investing 314, new accounts 315, help and support 316. In some other embodiments, the success notification page 300 may include profile and settings 310 option to change one or more settings associated with the user account, and a sign out 302 option to safely exit the online banking platform. In some other embodiments, the success notification page 300 may include a summary of the information 317 as entered by the user. The summary of the information 317 may include destination, dates of travel, account, contact phone number, additional information, and/or the like. In one aspect, the success notification page 300 may include an edit 318 option to change any information entered by the user. In another aspect, the success notification page 300 may include a delete 319 option to cancel the information entered.

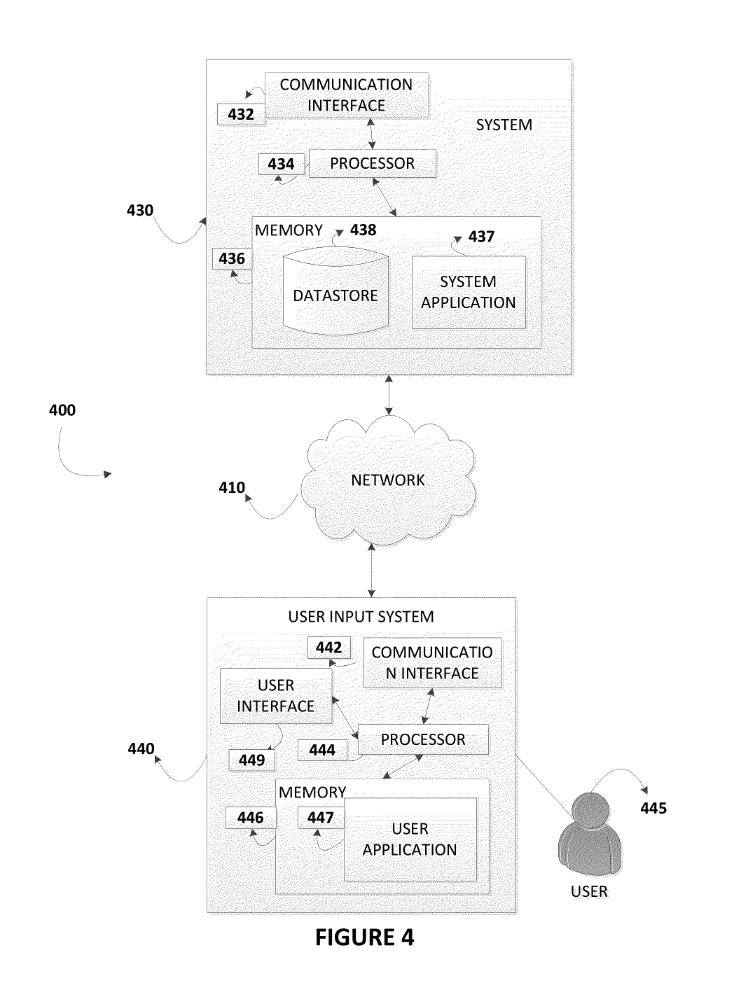

FIG. 4 presents an exemplary block diagram of the system environment 400 for implementing the process flow described in FIGS. 1 and 2 in accordance with embodiments of the present invention. As illustrated, the system environment 400 includes a network 410, a system 430, and a user input system 440. Also shown in FIG. 4 is a user 445 of the user input system 440. The user input system 440 may be a mobile device or other non-mobile computing device. The user 445 may be a person who uses the user input system 440 to execute a user application 447. The user application 447 may be an application to communicate with the system 430, perform a transaction, input information onto a user interface presented on the user input system 440, or the like. The user application 447 and/or the system application 437 may incorporate one or more parts of any process flow described herein.

As shown in FIG. 4, the system 430, and the user input system 440 are each operatively and selectively connected to the network 410, which may include one or more separate networks. In addition, the network 410 may include a telecommunication network, local area network (LAN), a wide area network (WAN), and/or a global area network (GAN), such as the Internet. It will also be understood that the network 410 may be secure and/or unsecure and may also include wireless and/or wireline and/or optical interconnection technology.

The user input system 440 may include any computerized apparatus that can be configured to perform any one or more of the functions of the user input system 440 described and/or contemplated herein. For example, the user 445 may use the user input system 440 to transmit and/or receive information or commands to and from the system 430. In some embodiments, for example, the user input system 440 may include a personal computer system (e.g. a non-mobile or non-portable computing system, or the like), a mobile computing device, a personal digital assistant, a mobile phone, a tablet computing device, a network device, and/or the like. As illustrated in FIG. 4, in accordance with some embodiments of the present invention, the user input system 440 includes a communication interface 442, a processor 444, a memory 446 having an user application 447 stored therein, and a user interface 449. In such embodiments, the communication interface 442 is operatively and selectively connected to the processor 444, which is operatively and selectively connected to the user interface 449 and the memory 446. In some embodiments, the user 445 may use the user application 447 to execute processes described with respect to the process flows described herein. Specifically, the user application 447 executes the process flow described in FIG. 1.

Each communication interface described herein, including the communication interface 442, generally includes hardware, and, in some instances, software, that enables the user input system 440, to transport, send, receive, and/or otherwise communicate information to and/or from the communication interface of one or more other systems on the network 410. For example, the communication interface 442 of the user input system 440 may include a wireless transceiver, modem, server, electrical connection, and/or other electronic device that operatively connects the user input system 440 to another system such as the system 430. The wireless transceiver may include a radio circuit to enable wireless transmission and reception of information. Additionally, the user input system 440 may include a positioning system. The positioning system (e.g. a global positioning system (GPS), a network address (IP address) positioning system, a positioning system based on the nearest cell tower location, or the like) may enable at least one of the user input system 440 or an external server or computing device in communication with the user input system 440 to determine the location (e.g. location coordinates) of the user input system 440.

Each processor described herein, including the processor 444, generally includes circuitry for implementing the audio, visual, and/or logic functions of the user input system 440. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 447 of the memory 446 of the user input system 440.

Each memory device described herein, including the memory 446 for storing the user application 447 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 4, the memory 446 includes the user application 447. In some embodiments, the user application 447 includes an interface for communicating with, navigating, controlling, configuring, and/or using the user input system 440. In some embodiments, the user application 447 includes computer-executable program code portions for instructing the processor 444 to perform one or more of the functions of the user application 447 described and/or contemplated herein. In some embodiments, the user application 447 may include and/or use one or more network and/or system communication protocols.

Also shown in FIG. 4 is the user interface 449. In some embodiments, the user interface 449 includes one or more output devices, such as a display and/or speaker, for presenting information to the user 445. In some embodiments, the user interface 449 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 445. In some embodiments, the user interface 449 includes the input and display devices of a mobile device, which are operable to receive and display information.

FIG. 4 also illustrates a system 430, in accordance with an embodiment of the present invention. The system 430 may refer to the “apparatus” described herein. The system 430 may include any computerized apparatus that can be configured to perform any one or more of the functions of the system 430 described and/or contemplated herein. In accordance with some embodiments, for example, the system 430 may include a computer network, an engine, a platform, a server, a database system, a front end system, a back end system, a personal computer system, and/or the like. Therefore, the system 430 may be a server managed by the entity. The system 430 may be located at the facility associated with the entity or remotely from the facility associated with the entity. In some embodiments, such as the one illustrated in FIG. 4, the system 430 includes a communication interface 432, a processor 434, and a memory 436, which includes a system application 437 and a datastore 438 stored therein. As shown, the communication interface 432 is operatively and selectively connected to the processor 434, which is operatively and selectively connected to the memory 436.

It will be understood that the system application 437 may be configured to implement any one or more portions of the various user interfaces and/or process flow described herein. The system application 437 may interact with the user application 447. It will also be understood that, in some embodiments, the memory includes other applications. It will also be understood that, in some embodiments, the system application 437 is configured to communicate with the datastore 438, the user input system 440, or the like.

It will be further understood that, in some embodiments, the system application 437 includes computer-executable program code portions for instructing the processor 434 to perform any one or more of the functions of the system application 437 described and/or contemplated herein. In some embodiments, the system application 437 may include and/or use one or more network and/or system communication protocols.

In addition to the system application 437, the memory 436 also includes the datastore 438. As used herein, the datastore 438 may be one or more distinct and/or remote datastores. In some embodiments, the datastore 438 is not located within the system and is instead located remotely from the system. In some embodiments, the datastore 438 stores information or data described herein.

It will be understood that the datastore 438 may include any one or more storage devices, including, but not limited to, datastores, databases, and/or any of the other storage devices typically associated with a computer system. It will also be understood that the datastore 438 may store information in any known way, such as, for example, by using one or more computer codes and/or languages, alphanumeric character strings, data sets, figures, tables, charts, links, documents, and/or the like. Further, in some embodiments, the datastore 438 may include information associated with one or more applications, such as, for example, the system application 437. It will also be understood that, in some embodiments, the datastore 438 provides a substantially real-time representation of the information stored therein, so that, for example, when the processor 434 accesses the datastore 438, the information stored therein is current or substantially current.

It will be understood that the embodiment of the system environment illustrated in FIG. 4 is exemplary and that other embodiments may vary. As another example, in some embodiments, the system 430 includes more, less, or different components. As another example, in some embodiments, some or all of the portions of the system environment 400 may be combined into a single portion. Likewise, in some embodiments, some or all of the portions of the system 430 may be separated into two or more distinct portions.

In addition, the various portions of the system environment 400 may be maintained for and/or by the same or separate parties. It will also be understood that the system 430 may include and/or implement any embodiment of the present invention described and/or contemplated herein. For example, in some embodiments, the system 430 is configured to implement any one or more of the embodiments of the process flows described and/or contemplated herein in connection any process flow described herein. Additionally, the system 430 or the user input system 440 is configured to initiate presentation of any of the user interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for a travel information communication system, the apparatus comprising:
a memory;
a processor; and
a module stored in memory, executable by the processor, and configured to:
receive a first status associated with a user account;
receive information from a user associated with the user account, wherein an information comprises at least a start date of travel, an end date of travel, and at least one destination of travel;
change status of the user account from the first status to a second status based on at least the start date of travel and the destination of travel; and
revert status of the user account to the first status based on at least the end date of travel.

2. The apparatus of claim 1, wherein a transaction initiated in the destination of travel between the start date of travel and end date of travel does not trigger a notification.

3. The apparatus of claim 2, wherein the transaction is initiated using at least one of a debit card, a credit card, and a mobile device.

4. The apparatus of claim 2, wherein triggering a notification comprises placing a hold on a transaction.

5. The apparatus of claim 2, wherein triggering a notification comprises limiting access to at least one of the debit card, the credit card, and the mobile device.

6. The apparatus of claim 4, wherein releasing the hold placed on a transaction comprises a user authentication requirement.

7. The apparatus of claim 2, wherein the notification is not triggered for user transactions at specific merchant locations.

8. The apparatus of claim 2, wherein the notification is not triggered for user transactions in specific currencies.

9. The apparatus for claim 2, wherein the notification is not triggered for user transactions at specific destinations of travel.

10. The apparatus for claim 1, wherein the start date of travel, the end date of travel, and the destination of travel are modifiable.

11. The apparatus of claim 1, wherein the destination of travel is modifiable during a time period between the start date of travel and the end date of travel.

12. The apparatus of claim 1, wherein the end date of travel is modifiable during the time period between the start date of travel and end date of travel.

13. The apparatus of claim 1, wherein receiving information comprises initiating the presentation of a first user interface to the user enabling the user to select a first option, wherein the first option includes account details.

14. The apparatus of claim 13, wherein receiving information comprises initiating the presentation of a second user interface to the user enabling the user to select a second option, wherein the second option includes help and support.

15. The apparatus of claim 14, wherein receiving information comprises initiating the presentation of a third user interface to the user enabling the user to enter at least the start date of travel, the end date of travel, and at least one destination of travel.

16. The apparatus of claim 13, wherein the presentation of the user interface is initiated on a mobile device.

17. The apparatus of claim 13, wherein the presentation of the user interface is initiated on an online banking platform.

18. The apparatus of claim 1, wherein changing the status of the user account comprises sending a notification of acknowledgement to the user.

19. A method for a travel information communication system via a transfer network, the method comprising:
receiving a first status associated with a user account;
receiving information from a user associated with the user account, wherein information comprises at least a start date of travel, an end date of travel, and at least one destination of travel;
changing status of the user account from the first status to a second status based on at least the start date of travel and the destination of travel; and
reverting status of the user account to the first status based on at least the end date of travel.

20. A computer program product for a travel flag communication system via a transfer network, the computer program product comprising a non-transitory computer-readable medium comprising code causing a first apparatus to:
receive a first status associated with a user account;
receive information from a user associated with the user account, wherein information comprises at least a start date of travel, an end date of travel, and at least one destination of travel;
change status of the user account from the first status to a second status based on at least the start date of travel and the destination of travel; and
revert status of the user account to the first status based on at least the end date of travel.
